(19) United States
(12) Patent Application Publication
(10) Pub. No.: US 2010/0207000 A1
(43) Pub. Date: Aug. 19, 2010

(54) Door Attachment

(76) Inventor: Sam KRAUSZ, Brooklyn, NY (US)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/614,787

(22) Filed: Nov. 9, 2009

Related U.S. Application Data
(60) Provisional application No. 61/207,797, filed on Feb. 18, 2009.

(51) Int. Cl. F16M 13/00

(52) U.S. Cl. 248/222.14; 248/220.21; 248/225.21

(57) ABSTRACT

A door attachment configured for mounting over a top of a door, the door attachment including a horizontal support configured to at least partially rest on the top of the door; a first substantially vertical member extending from the horizontal support configured to contact a first face of the door; and a second substantially vertical member extending from the first horizontal support. The second substantially vertical member has a first surface configured to contact a second face of the door opposite the first face of the door. The second substantially vertical member includes a mounting mechanism configured to slideably receive the horizontal support, the mounting mechanism extending in a longitudinal direction of the horizontal support away from the second face of the door. A locking mechanism is provided that prevents movement of the horizontal support relative to the mounting mechanism when engaged

### CROSS REFERENCE TO RELATED APPLICATIONS

The present application claims priority to U.S. Provisional Patent Application Ser. No. 61/207,797, which was filed on Feb. 18, 2009, the disclosure of which is incorporated herein in its entirety.

### BACKGROUND OF THE INVENTION

1. Field of the Invention

The present invention relates to door attachments, and more specifically, to an over-the-door attachment that is adjustable to any width door.

2. Description of the Related Art

Over-the-door hangers have been used for a number of years. The basic structure of such a hanger generally includes a metal or molded plastic piece that can be hung over the top of a door and extends down the face of the door, terminating in a hook used to support the item being hung. The advantage of these hangers is that items such as wreaths, hangers, and the like can be hung without permanently attaching anything to the door. This is especially useful for hanging a seasonal item, such as a wreath, which is only hung on the door for a relatively short period of time during the year.

FIG. 13 is a prior art over-door hook having a fixed width W that is designed to fit most doors. However, given the variation in door widths, the over-door hook shown in FIG. 13 is generally loose on the door top and is therefore not secure. Further, because this over-door hook is not tight, it tends to move thereby damaging the door. To create a tight fit for the over-door hooks, users have added material between the door and one of the leg portions 110, and 120 to minimize the excess space between the over-door hook and the door. Further, some manufacturers have created an acute angle between legs 110 and 120 to try to squeeze the door between the legs of the over-door hook thereby minimizing the potential for movement. However, none of these prior art over-door hooks provide an over-door hook attachment adaptable to any width door.

### SUMMARY OF THE INVENTION

According to one embodiment of the invention, an over-door hanger is configured to contact a top of a door and opposing faces of the door. When the door is in its closed position, only a horizontally extending element is arranged between the door top and a door jamb. The over-door hanger has at least one slideably mounted vertical member configured to adjust a mounting width of the over-door hanger so that the over-door hanger is snugly affixed to the door.

Briefly stated, the invention is directed to a door attachment configured for mounting over a top of a door, the door having opposed first and second faces. The door attachment includes a horizontal support configured to at least partially rest on the top of the door, a first substantially vertical member extending from the horizontal support configured to contact the first face of the door, and a second substantially vertical member extending from the first horizontal support. The second substantially vertical member has a first surface configured to contact the second face of the door. The second substantially vertical member includes a mounting mechanism configured to slideably receive the horizontal support, the mounting mechanism extending in a longitudinal direction of the horizontal support away from the second face of the door and a locking mechanism configured to releaseably secure the horizontal support against movement in at least one direction relative to the mounting mechanism.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a perspective view of an over-door attachment in accordance with the invention;

FIG. 2 is a perspective exploded view of the over-door attachment of FIG. 1;

FIG. 3 is a side view of the over-door attachment of FIGS. 1 and 2;

FIG. 4 is a partial sectional view of a locking mechanism along line 4-4 of FIG. 1;

FIG. 5A is a perspective view of an over-door attachment according to a second embodiment of the invention;

FIG. 5B is a perspective view of an over-door attachment according to a third embodiment of the invention;

FIG. 6 is a perspective exploded view of the over-door attachment according to a fourth embodiment of the present invention;

FIG. 7 is a partial sectional view of the over-door attachment of FIG. 6 when assembled;

FIG. 8 is a side view of an over-door attachment according to a fifth embodiment of the invention;

FIG. 9 is a hook attachment used with the inventive over-door attachment;

FIG. 10 is a shelf attachment used with the inventive over-door attachment;

FIG. 11 is a hanger attachment used with the inventive over-door attachment;

FIG. 12 is a side view of an over-door attachment in accordance with a sixth embodiment of the invention; and

FIG. 13 is an over-door hook according to the prior art.

### DETAILED DESCRIPTION OF THE PRESENTLY PREFERRED EMBODIMENTS

Disclosed is an over-door attachment that is adjustable to fit snugly on a door. In a preferred embodiment, a first L-shaped door component and a second vertically oriented component are operatively arranged with each other to bound therebetween a variable width compartment, such as a door. The second vertically oriented component is configured for retaining therein the first L-shaped component. A locking mechanism is provided to prevent motion of the L-shaped component when the lock mechanism is engaged.

As shown in FIG. 1, an over-door attachment 10 in accordance with the invention includes a horizontal support, namely a first L-shaped component 12 and a second vertically oriented door component 14. The two components 12, 14 are arranged for use on a door 16. The over-door attachment 10 is configured so that width 20 is variable to match a door width 20A. The L-shaped component 12 is laterally moveable along line 26. Lateral motion of L-shaped member 12 in the directions shown by double-headed arrow 26 varies the space 18 bounded by L-shaped member 12 and the second vertically oriented door component 14.

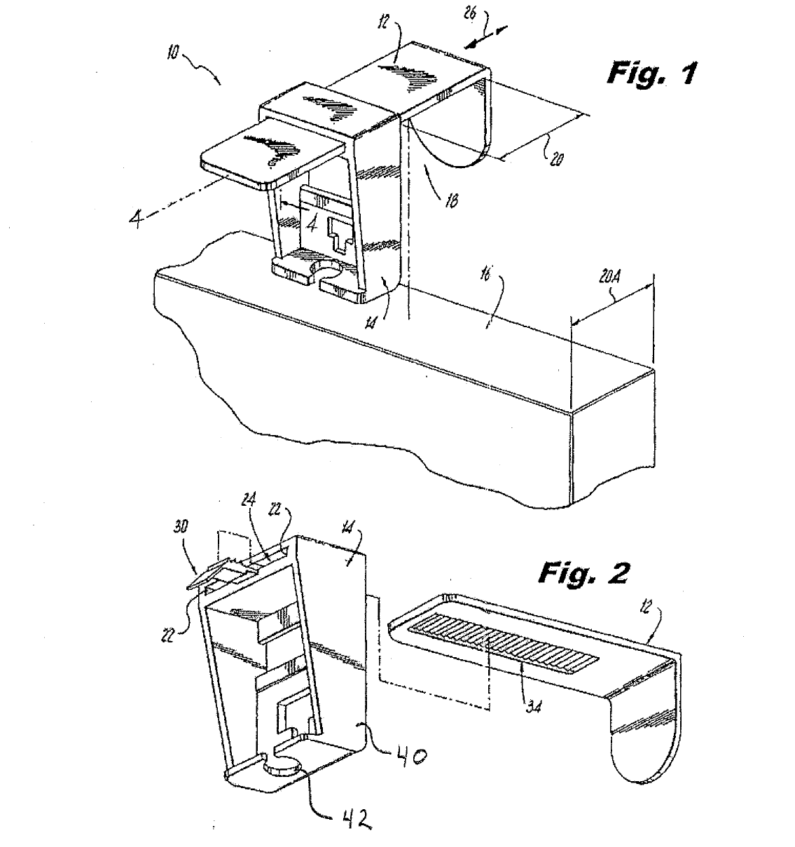

As shown in FIG. 2, the L-shaped component 12 includes a first portion 34 having a sawtooth formed therein. The L-shaped component 12 is configured to mate with the vertically oriented component 14 through a slot 24. Slot 24 has sidewalls 22 spaced apart from one another so that the width of slot 24 is only slightly larger than the width of L-shaped component 12. A resilient tab 30 is provided on component 14. Tab 30 includes a sawtooth configured to mate with the sawtooth 34 of L-shaped component 12 as shown in FIG. 4. When the sawtooth of tab 30 mates with the sawtooth 34 of the L-shaped component 12, the L-shaped component 12 is prevented from moving longitudinally in at least one direction in slot 24. In one embodiment of the invention, the vertical component 14 includes a component mount 42. As discussed in more detail below, the component mount 42 is configured to securely mount components to the door 16.

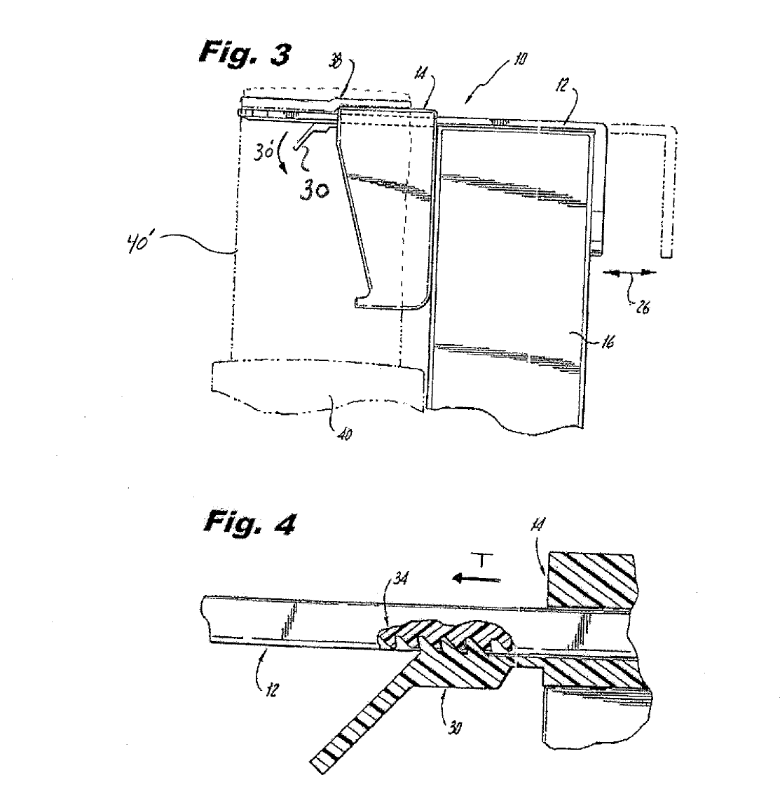

FIG. 3 shows the over-door attachment 10 in operation. As shown, the first L-shaped component 12 is placed over the door 16 such that the vertically oriented component 14 is against a first face of the door 16. The L-shaped component 12 is then moved toward a second face of door 16 as shown by arrow 26 in the direction to the left in FIG. 3. When the door attachment 10 is snugly affixed to door 16, L-shaped component 12 is secured against further movement by tab 30. To release the L-shaped component 12 for lateral motion, tab 30 is moved in a direction of arrow 30′. In one embodiment of the invention, a tab 38 extends from over-door attachment 10. The tab 38 is configured for hanging bags and the like such as a duffle bag 40, shown in phantom. As shown, a duffle bag strap 40′ is placed over a top of the tab 38.

FIG. 4 is a partial cross section showing the tab 30 mating with the sawtooth 34 of the L-shaped component 12. As shown, the sawtooth 34 is preferably angled so that the L-shaped component 12 can be in a direction T without releasing tab 30. Tab 30 is then released to move the L-shaped component 12 away from vertical component 14, in a direction opposite direction T.

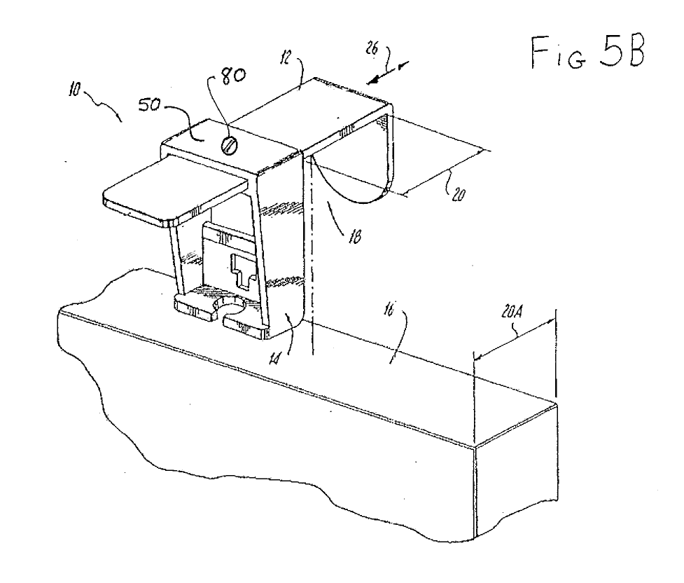

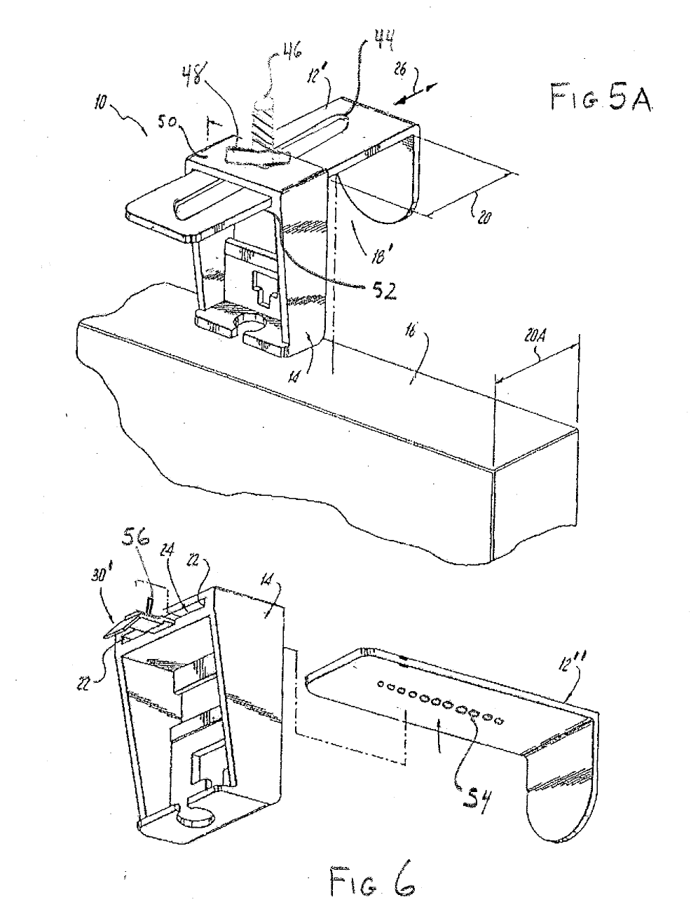

FIG. 5A is a second embodiment of the over-door attachment 10. As shown, the L-shaped component 12′ has a longitudinally extending slot 44. The vertically extending component 14 includes a threaded rod 46 that extends through slot 44 to cross member 52. A wing nut 48 or the like is tightened on threaded rod 46 to hold the L-shaped component 12′ in place. This embodiment provides a continuously adjustable space 18′, in contrast to the stepwise adjustable space 18 shown in FIG. 1. As would be readily understood by one of ordinary skill in the art, the vertical component 14 can alternatively include a through hole on its top surface 50 and a threaded portion in cross member 52 corresponding to the through hole on the top surface 50. A threaded screw can then be inserted through a hole on surface 50 and tightened so that the top surface 50 is pressed against the L-shaped component 12′ to prevent movement of the L-shaped component 12′ once the appropriate space 18′ corresponding to the door width 20A is met.

FIG. 5B depicts a variation of the locking mechanism shown in FIG. 5A. In FIG. 5B, the L-shaped component 12 does not have a slot. A setscrew 80 is threaded into top surface 50 of the vertical component 14. Setscrew 80 is tightened so that it is pressed against the L-shaped component 12 to prevent movement of the L-shaped component 12 once the appropriate space 18 corresponding to the door width 20A is met.

FIG. 6 depicts a second locking mechanism that includes a post 56 mounted on tab 30′ and a plurality of evenly spaced holes 54 on L-shaped component 12″. While tab 30 is shown including only a single post 56, it should be noted that a plurality of posts 56 may be used, spaced apart from one another by a distance equal to the spacing between holes 54. Further, holes 54 may be through holes or blind holes. It should be noted that holes 54 and posts 56, while shown having matching circular cross sections, holes 54 and posts 56 can have any shape as long as they have matching cross section.

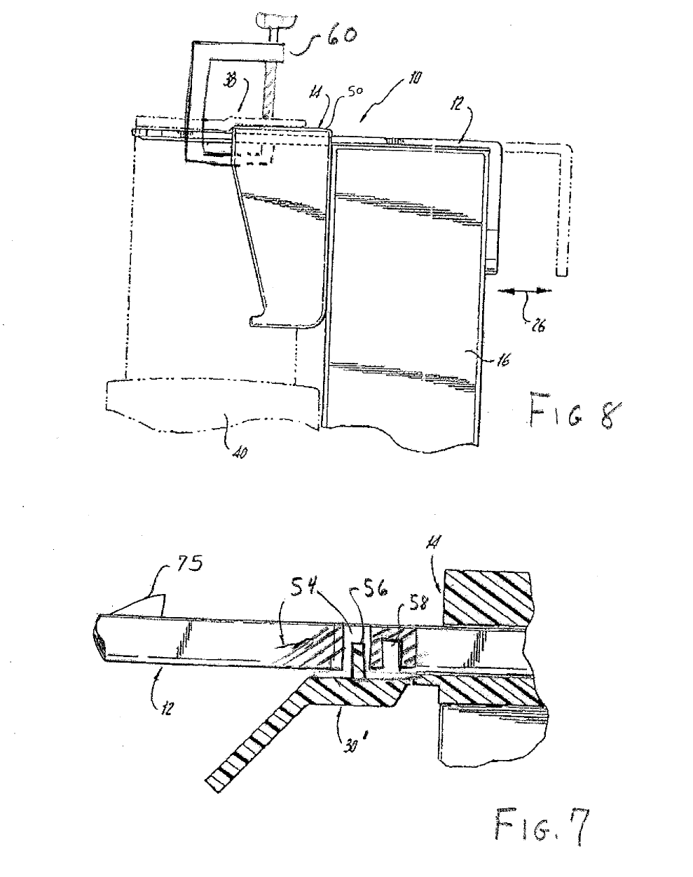

FIG. 7 is a cross sectional view of a tab 30′ with post 56 and a through hole 54. FIG. 7 also shows a blind hole 58. A wedge shaped protrusion 75 extends from a surface of L-shaped member 12. Preferably, at least one of slot 24 and wedge shaped protrusion 75 is sufficiently resilient so that the wedge shaped protrusion 75 travels through slot 24 in only one direction. In this manner, the L-shaped member 12 cannot be disengaged from the second vertically oriented door component 14 once it is engaged as shown in FIG. 7.

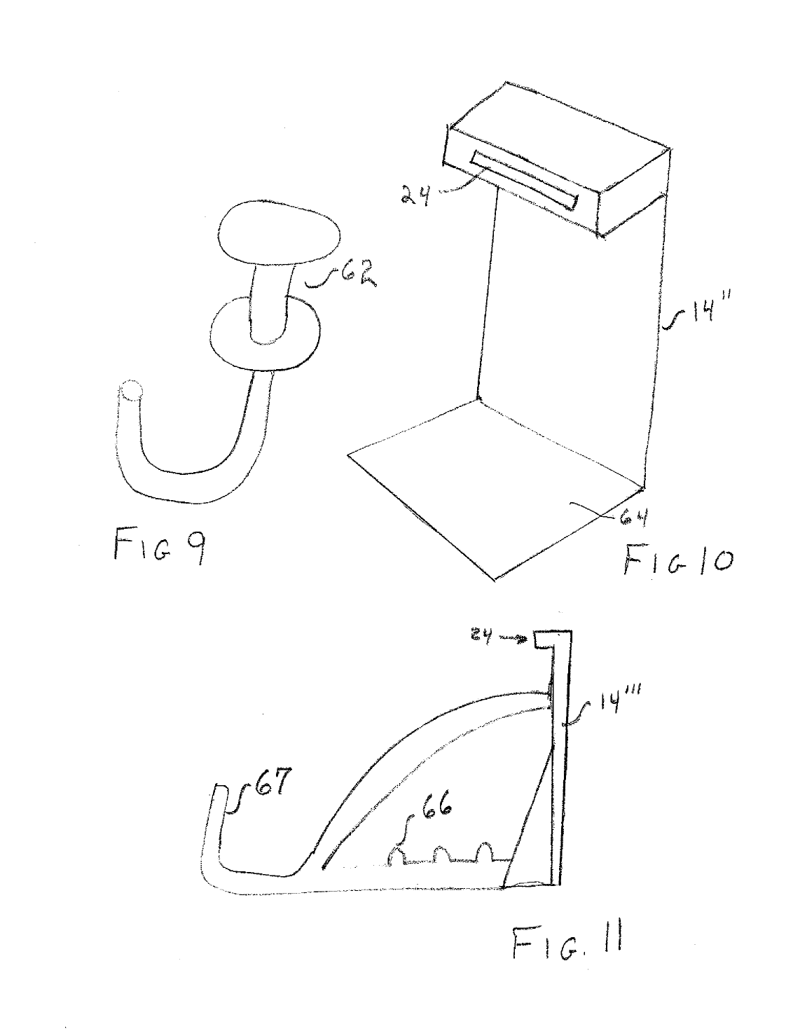

In an alternative embodiment shown in FIG. 8, a C-clamp 60 locks the L-shaped component in place to vertically extending component 14. While the C-clamp 60 is depicted schematically, it should be noted that in one embodiment, a threaded hole in a top surface 50 of vertically extending component 14 has a screw threaded therein to frictionally lock L-shaped component 12 in place. In other words, the channel 24 forms the C-clamp 60.

FIG. 9 is an example of a component that is received in component mount 42 shown in FIG. 2. FIG. 9 depicts a hook having a circular body 62 configured to mate with the component mount 42. Alternatively, the component that is received in component mount 42 can be a hanger holder, a shelf, a basket, or any other desired component.

FIG. 10 depicts a shelf 64 that is formed as a portion of vertically extending component 14″. As shown, there is a slot 24 configured to mate with L-shaped component 12, as discussed above. The vertically extending component 14″ includes at least one of the locking mechanisms discussed above. In an alternative embodiment (not shown), the shelf 64 includes a mating component similar to mating component 62 configured to mate with component mount 42 of the vertically extending component 14.

FIG. 11 depicts a hanger holder including hanger separators 66 and a hook 67. The vertically extending member 14′″ includes a slot 24 configured to mate with L-shaped component 12. It should be noted that any of the locking mechanisms discussed above could be used with the assembly shown in FIG. 11.

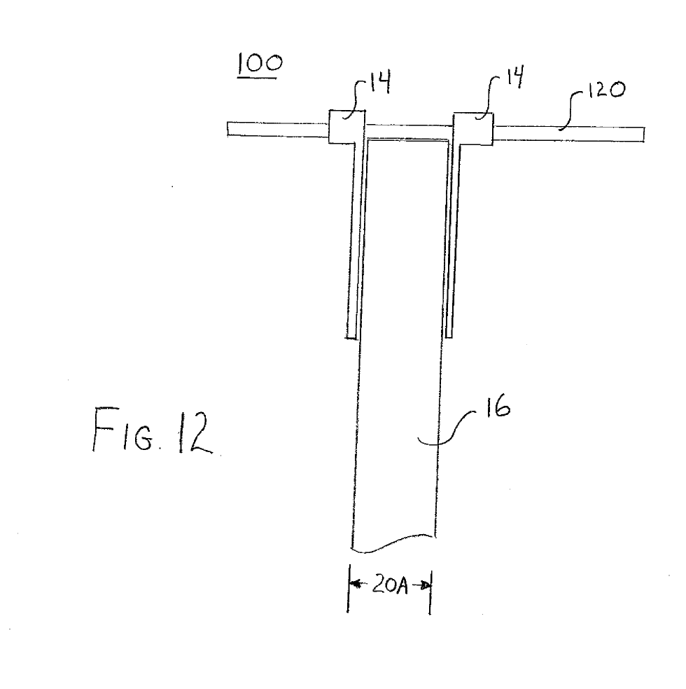

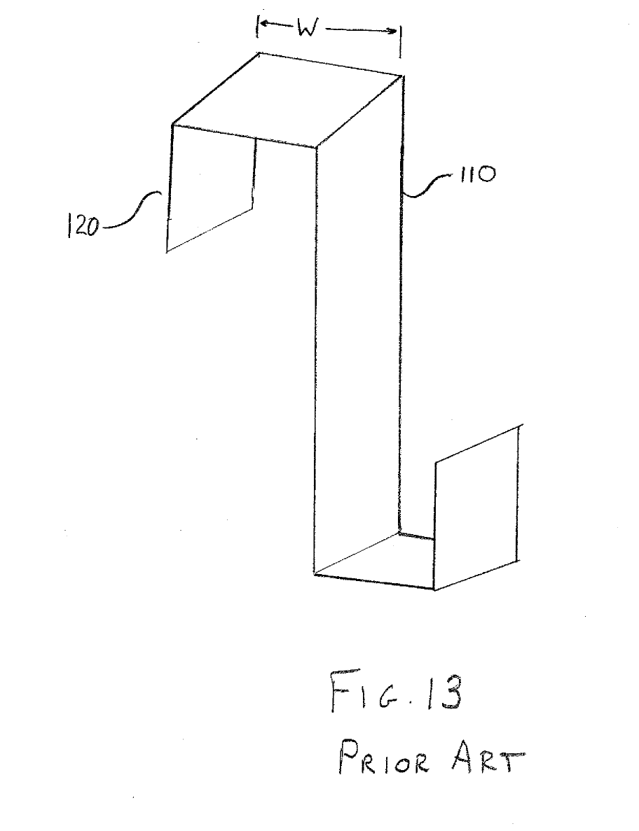

As shown in FIG. 12, an over-door attachment 100 in accordance with an alternative embodiment invention that includes a first component 120 and two vertically oriented door components 14. The three components 120, 14 are arranged for use on the door 16. The over-door attachment 100 is configured so that both vertically oriented door components 14 are laterally moveable to match the door width 20A.

Thus, while there have shown and described and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A door attachment configured for mounting over a top of a door, the door having opposed first and second faces, the door attachment comprising:
a horizontal support configured to at least partially rest on the top of the door;
a first substantially vertical member extending from the horizontal support configured to contact the first face of the door;
a second substantially vertical member extending from the first horizontal support, the second substantially vertical member having a first surface configured to contact the second face of the door, the second substantially vertical member comprising:
a mounting mechanism configured to slideably receive the horizontal support, the mounting mechanism extending in a longitudinal direction of the horizontal support away from the second face of the door; and
a locking mechanism configured to releaseably secure the horizontal support against movement in at least one direction relative to the mounting mechanism.

2. The door attachment of claim 1, wherein the horizontal support has a substantially rectangular cross section.

3. The door attachment of claim 1, wherein the mounting mechanism at least partially encircles the horizontal support.

4. The door attachment of claim 1, wherein the first substantially vertical member is integrally formed with the horizontal support.

5. The door attachment of claim 1, wherein the mounting mechanism is continuously adjustable over a predetermined range.

6. The door attachment of claim 1, wherein the mounting mechanism is adjustable over a predetermined range in a stepwise manner.

7. The door attachment of claim 1, wherein the lock mechanism comprises:
a sawtooth on a longitudinal portion of one of the horizontal support and the mounting mechanism; and
means for engaging the sawtooth, positioned on the other of the horizontal support and the mounting mechanism and configured to cooperate with the sawtooth to prevent movement of the mounting mechanism when the means for engaging engages the sawtooth.

8. The door attachment of claim 1, wherein the lock mechanism comprises:
a plurality of holes on a longitudinal portion of one of the horizontal support and the mounting mechanism; and
a peg on the other of the horizontal support and the mounting mechanism, the peg being configured to removeably mate with a selected one of the plural holes.

9. The door attachment of claim 1, wherein the lock mechanism comprises:
a longitudinal slot extending over a portion of the horizontal support;
a threaded post extending from the mounting mechanism through the slot; and
a threaded element configured to thread on the threaded post and lock the mounting mechanism to the horizontal support.

10. The door attachment of claim 9, wherein the threaded element is a wing nut.

11. The door attachment of claim 1, wherein the locking mechanism is a C-clamp configured to increase a friction between the mounting mechanism and the horizontal support to prevent relative movement therebetween.

12. The door attachment of claim 1, wherein the first substantially vertical member comprises:
a second mounting mechanism configured to slideably receive the horizontal support, the second mounting mechanism extending in a longitudinal direction of the horizontal support away from the first face of the door.

13. The door attachment of claim 1, wherein at least one of the first and second substantially vertical members further comprises a hook.

14. The door attachment of claim 1, wherein at least one of the first and second substantially vertical members further comprises a pants holder.

15. The door attachment of claim 1, wherein the locking mechanism is a setscrew configured to increase a friction between the mounting mechanism and the horizontal support to prevent relative movement therebetween.

16. The door attachment of claim 1, wherein at least one of the first and second substantially vertical members further comprises a hook.

17. The door attachment of claim 1, wherein at least one of the first and second substantially vertical members further comprises a shelf.

18. The door attachment of claim 1, wherein
the mounting member comprises a channel, and
the horizontal support comprises a wedge shaped protrusion configured to prevent removal of the horizontal support from the channel.
